(19) United States
(12) Patent Application Publication
(10) Pub. No.: US 2011/0293151 A1
(43) Pub. Date: Dec. 1, 2011

(54) METHOD AND DEVICE FOR QUANTIFYING SURFACE PARTICULATE CONTAMINANTS BY IMPROVED ANALYSIS

(75) Inventor: Isabelle Tovena-Pecault, Leognan (FR)

(73) Assignee: Commissariat a L'Energie Atomique et aux Energies Alternatives, Paris (FR)

(21) Appl. No.: 12/995,843

(22) PCT Filed: Jun. 24, 2009
(86) PCT No.: PCT/EP2009/057931

§ 371 Date: Dec. 2, 2010

(30) Foreign Application Priority Data
Jun. 26, 2008 (FR) 08 54261

(51) Int. Cl. G06K 9/00

(52) U.S. Cl. 382/128

(57) ABSTRACT

The invention concerns a new method for quantifying particulate contaminants with increased reliability and that makes it possible to detect all particulate sizes according to standard ISO 14644-9.

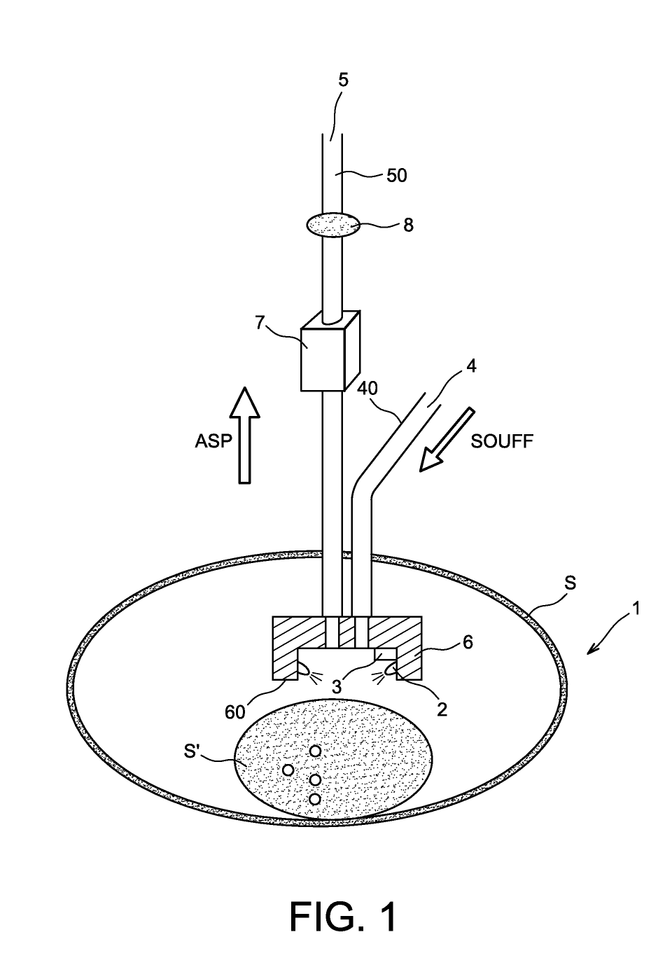

According to the invention, blowing/suction is done on a sampled surface S′, followed by a combination of analysis through optical counting of the suctioned particulate contaminants with a unit size below a value X2 and digital computation between two digital photos taken of the surface S′ before and after blowing/suction, respectively, to quantify the particulates with a unit size above a value X1.

### TECHNICAL FIELD

The invention concerns the field of ultra cleanliness, with a base of materials (or nanomaterials), manufactured or assembled in clean rooms or similar controlled environment zones.

The invention more particularly concerns the improvement of the quantitative analysis of surface particulate contaminants likely to be found in these clean rooms or zones.

The invention can also apply to the testing and characterization of the surfaces.

### BACKGROUND OF THE INVENTION

A contaminant is designated in standard ISO 14644-4 as follows: “Any particulate, molecular, non-particulate or biological entity of a nature to produce an undesirable effect on the product or method.”

In the context of the invention, we are interested exclusively in surface particulate contaminants. To date, only one standard makes it possible to classify the state of the surface cleanliness on which deposited particulate contaminants are present: standard IEST 1246 D.

A new international standard ISO 14644-9 to classify the state of particulate cleanliness of the surfaces is in the process of being approved. The surface particulate contaminants considered according to this new standard are those whereof the unitary size is generally between 0.05 μm and 500 μm for the needs of the classification. Aside from this large size range, the new standard proposes considering new specific ranges included in this range. This new standard involves determining the number per m² of these surface particulate contaminants. Moreover, contaminants of a biological origin can be likened to surface particulates when they are dead. Dead biological contaminants therefore fall within the scope of the invention.

To date, to check the particulate cleanliness of surfaces according to standard IEST 1246 D, probes are used that all operate on basically the same principle: filtered air is blown onto a surface, then the air containing any particulate contaminants is suctioned.

Thus, one widespread apparatus in the field is that marketed under the name Q-III® by the company Dryden Engineering, whereof the operating principle through counting subsequent to the suction, using a diode laser, is described in U.S. Pat. No. 5,253,538. The operating conditions of this apparatus as indicated in the patent and in the instructions indicate that the detection head passes over the object to be analyzed at a speed of 10 LFPM (Linear Feet Per Minute) with sampling periods of 1, 3 or 6 seconds (see column 4, lines 49-51 of the patent). This apparatus is designed with five suction channels measuring 0.3 μm, 0.5 μm, 1.0 μm, 5.0 μm and 10 μm, respectively.

One identified drawback of this apparatus by the company Applied Materials concerns the potential misalignment of the probe head with an object to be analyzed when the latter is not completely flat. Thus, Applied Materials contemplated a solution, as described in U.S. Pat. No. 5,939,647, which consists of making the sampling head rotary so as to allow positioning flexibility.

Recent studies by the applicant have shown that, whatever the currently marketed quantification apparatus operating on the combined principle of filtered air/suction, the measurements done were not reliable, and furthermore they did not cover the spectrum of particulate sizes contemplated in the new standard ISO 14644-9.

The aim of the invention is then to propose a solution that makes it possible to respond to this dual issue.

### BRIEF DESCRIPTION OF THE INVENTION

To that end, the invention relates to a method for quantifying surface particulate contaminants likely to be present on an object, according to which the following steps are carried out:

a) sampling a surface to be analyzed,

b) raking lighting of the sampled surface,

c) taking a first digital photo of the lighted surface to determine elements with a unit size larger than a value X1,

d) blowing clean air on the photographed surface,

e) suction of the blown air containing any particulate contaminants towards at least one counting device suitable for quantifying particulates with a unit size smaller than a value X2,

f) taking a second digital photo of the same lighted surface under the same conditions as the first digital photo in order to differentiate, among the elements, the particulate contaminants from surface flaws of the object,

g) quantifying particulate contaminants with a unit size higher than X1 by determining the proportion of photographic pixels belonging to any surface contaminants by comparing the first and second digital photos. Steps a) to g) are advantageously done without relative movement in relation to the object.

According to one advantageous embodiment of the invention, an additional step h) is carried out according to which, if X1 is less than X2, a comparison of the quantifications is done between the suctioned and counted particulates and the particulates quantified by digital photography.

The counting device(s) according to the invention can be made up of any type of apparatuses implementing an aerosol metrology technology. For example, an optical device can preferably be contemplated, of the laser diode type, so as to quantify particulates smaller than 10 μm. A condensation nucleus counter can also be considered to quantify nanometric particulates. Counters can also be considered using an electric-type counting, such as E.L.P.I. (Electrical Low Pressure Impactor) counters.

In the context of the invention, one may associate online, i.e. on the same suction path, an optical counting device with a condensation nucleus counter and/or with an E.L.P.I. counter.

Typically, an optical counter can be used, of the laser diode type, whereof the lower counting limit X3 is in the vicinity of 0.1 μm and the upper limit X2 is in the vicinity of 10 μm.

Likewise, it is possible to use a condensation nucleus counter whereof the lower counting limit X3 corresponds to about 5 to 7 nm (nanometers).

Thus, in the context of the invention, it is possible to quantify:
in case of non-overlapping value (i.e. X1>X2), the size range between X3 and X2 (for example between 0.1 μm and 5 μm) directly by counting and the range beyond X1 (for example beyond the μm and up to the cm) directly by photo comparison and digital computation,
in case of value overlap (i.e. X1<X2), the range between X3 and X1, between X1 and X2 and beyond X2 by comparison of the quantifications between the suctioned and counted particulates and the particulates quantified by digital photo.

Of course, the value X1 depends on the digital photo device used and the value X2 depends on the counting device. Those skilled in the art will thus make sure to adapt the optical counting and digital photography means, respectively, as a function of the statistical distribution they seek to obtain in a privileged manner. For example, depending on the nature of the object, they may seek to determine, statistically with increased precision, the particulates between 1 and 5 μm and between 5 μm and 10 μm, respectively. They may the choose a photo-digital device with a resolution in the vicinity of 5 μm (X1) and an optical counter counting the particulates between 1 μm (X3) and 10 μm (X2).

“Clean air” here and in the context of the invention means that the blown air is filtered so as not to contain particulates with a size larger than a given value, preferably equal to the lower counting limit X3 of the device.

The inventor was able to show that the detection and counting devices using the combined blowing/suction principle were combining two limits: on one hand in terms of the extraction strictly speaking of the particulates, and on the other hand in terms of the detection or analysis strictly speaking of the particulates.

The inventor therefore decided to push back each of these two limits, respectively.

The improvement of the extraction is the object of the patent application filed the same day as this application and entitled “method and device for quantifying surface particulate contaminants by improved extraction.”

Concerning the other limit, the inventor identified that the probes according to the state of the art had to be used with a relative movement in relation to the object and that such a movement would not make it possible to have a reliable and reproducible measurement. Indeed, during each sampling during movement of the probe, the surface particulate concentration is modified. This concentration is a priori decreased, unless the contact between the probe and the surface to be sampled alters one or the other of the surfaces in contact and thereby generates particulates. Thus, the number of particulates detected is not necessarily that initially precisely present on the object in a given area.

Moreover, the inventor was able to see that the probes according to the state of the art had to be moved on the object to be tested only via an operator's wrist. This makes the measurement very dependent on the pressure and incline applied on the probe.

The inventor thus concluded that a static and statistical detection by particulate size ranges (on one hand corresponding to the X3-X2 interval related to the counting device, for example between 0.1 and 10 μm, to the possible overlap interval X1-X2, for example between 5 and 10 μm and beyond X1, for example beyond 10 μm) was more appropriate.

In other words, the method according to the invention makes it possible to cleanly confine a surface sample of an object to be qualified in terms of surface particulate or biological cleanliness.

The method according to the invention also makes it possible, owing to the taking of digital photos and the comparison made before and after blowing and extraction, to know the surface distribution of the particulate contaminants on the object.

According to one advantageous embodiment, the suctioned particulates are collected downstream of the counting device. It is thus possible to perform physic-chemical analyses after the collection. It is also possible to confine the suctioned and collected particulates and subject them to a specific treatment as a function of the danger inherent to the nature of the particulates (chemical or radiation-chemical toxicity . . . ).

Preferably, raking lighting is done in the ultraviolet range. It is thus possible to distinguish the particulate contaminants from the surface flaws likely to be present on the object.

The invention also concerns a device for quantifying surface particulate contaminants likely to be present on an object, comprising:
lighting means for performing raking lighting of a sampled surface,
digital photography means for taking digital photos of the lighted surface, the digital photography means being suitable for determining the elements with a unit size larger than a value X1,
blowing and suction means for blowing clean air on the photographed surface and suctioning the blown air containing any particulate contaminants, respectively,
a counting device suitable for quantifying particulates with a unit size below a value X2,
digital computation means for determining the proportion of photographic pixels belonging to surface contaminants with a unit size above a value X1 by comparison between two digital photos taken before and after blowing and suction.

The means for blowing clean air according to the invention may advantageously comprise oblique and raking jets as proposed in the patent application filed the same day as this application and entitled “method and device for quantifying surface particulate contaminants by improved extraction.”

As collection means, the device can advantageously comprise a filtration membrane whereof the pore size is in the vicinity of X3, the membrane being mounted in the suction means so as to collect the suctioned particulate contaminants. The pore size X3 is therefore in the vicinity of the lower size value of the particulates effectively counted by the counting device(s) used according to the invention.

The lighting means can advantageously comprise ultraviolet lighting means that make it possible to selectively detect the fluorescent particulates.

The lighting means are advantageously laser diodes.

The device according to the invention advantageously comprises a contact sole with the object, the sole being made of material(s) chemically neutral with regard to the object.

In the context of the invention, the expression “chemically neutral” means that the considered part(s) is (are) made from one or several materials having all of the following characteristics:
a degassing rate defined, for example, such that the total mass loss is less than 1% according to the ECSS Q70-2A test and such that the recondensated volatile quantity is less than 0.1% according to the same test,
a chemical inertia defined, for example, such that the mass loss or gain following a potential chemical reaction is less than 1% by mass,
an ability to generate particulates defined, for example, such that the surface contamination level is below a level 100 for example, according to standard IEST 1246D.

The device according to the invention can also comprise means for generating a non-contaminant air cushion below the contact sole in order to move the device between two different surfaces to be sampled. It is thus easy to move the device between two surfaces to be sampled and thereby analyze large object surfaces.

The invention lastly concerns the application of the method described above or the aforementioned device to the quantitative analysis of surface particulate contaminants in controlled environment zones. In certain industries (spatial, micromechanics, optics, nanotechnologies as well as the pharmaceutical and agri-food industries, hospitals . . . ), mastery of the particulate contamination goes through sampling on solid supports on the process line. However, few industries have their own chemical analysis laboratory. Consequently, a device according to the invention makes it possible to have portable and real-time means for testing the cleanliness of the surfaces of an object.

### BRIEF DESCRIPTION OF THE DRAWINGS

Other advantages and features of the invention will better emerge from reading the detailed description of one embodiment done in reference to the sole FIGURE.

### DETAILED DESCRIPTION OF SPECIFIC EMBODIMENTS

The device according to the invention 1 diagrammatically illustrated makes it possible to quantify and confine particular contaminants with a unit size between a lower value in the vicinity of 0.1 μm and an upper value of up to a cm, that are present on the surface of an object S whereof one wishes to test and/or decontaminate the entire surface.

The device 1 first comprises lighting means 2 to perform raking lighting of a sampled surface S′. They can advantageously be made up of laser diodes. The raking lighting is preferably done using laser diodes emitting in the ultraviolet range.

Digital photography means 3 are provided to take digital photos of the lighted surface. These digital photography means are suitable for determining elements with a unit size between a value X1 in the vicinity of 10 μm up to a value in the vicinity of a CM.

Blowing 4 and suction 5 means are also provided to blow clean air on the photographed surface and suction the blown air containing any particulate contaminants, respectively. These blowing means 4 and 5 advantageously comprise a duct 40, 50.

In the illustrated embodiment, the laser diodes 2, the digital photo means 3 and part of the ducts 40, 50 are installed in a same housing 6 that thus constitutes a detection head. The aeraulics of the blowing and suction provided below the head 6 may advantageously be done as described and claimed in the patent application entitled “method and device for quantifying surface particulate contaminants by improved extraction” filed by the applicant on the same day as this application.

An optical counting device 7 is installed downstream. It is suitable for quantifying particulates with a unit size between a lower value X3 in the vicinity of 0.1 μm and an upper value X2 in the vicinity of 10 μm that pass in the duct 50.

Lastly, the device according to the invention comprises digital computation means, not shown, that make it possible to determine the proportion of photographic pixels belonging to the particulate contaminants present on the surface S′ through comparison between two digital photos taken before and after blowing and suction, respectively.

The housing 6 comprises a sole 60 for contact with the object, said sole being made of material(s) that is (are) chemically neutral relative to the surface S of the object. This sole 60 can advantageously be made from Teflon. The geometry of the sole 60 (for example square or round) can advantageously be adapted to the geometry of the surfaces S′ to be qualified according to standard ISO 14644-9.

The operation of the device 1 according to the invention is as follows:

a) positioning the head portion 60 of the device 1 on a surface to be analyzed S′,

b) raking lighting of the sampled surface by the laser diodes 2,

c) taking a first digital photo of the lighted surface S′ using the digital camera 3 to determine the elements with a unit size larger than the value X1 in the vicinity of 10 μm,

d) blowing clean air over the photographed surface through the duct 4 (direction SOUFF in the sole FIGURE),

e) suctioning the clean air containing any particulate contaminants through the duct 4 (direction SOUFF in the sole FIGURE) towards the optical counting device 7 suitable for quantifying the particulates with a unit size between X3=0.1 μm and X2 in the vicinity of 10 μm,

f) taking a second digital photo of the same lighted surface S′ under the same, identical aperture, focal, spatial conditions) as the first digital photo by the digital camera through the digital photograph cell 3. This step f) makes it possible to differentiate, among the elements, the particulate contaminants from the surface flaws of the object;

g) quantifying particulates with a unit size higher than the upper value of 10 μm by determining the proportion of photographic pixels belonging to any surface contaminants by comparing the first and second digital photos owing to digital computation means.

The head 6 of the device is kept static, i.e. it does not move relative to the object S during the operation from a) to g).

The head 6 of the device 1 may potentially move autonomously on a non-contaminant air cushion for a point by point remotely guided analysis or automated large surface test.

All of the surface particulate contaminants initially present on the surface S′ are collected by a membrane 8 placed downstream from the optical counting device in the duct 50. The membrane 8 comprises pores with a unit size in the vicinity of 0.1 μm. The recovery of the collection membrane 8 allows subsequent physico-chemical analyses. The membrane 8 can be confined and undergo chemical or physico-chemical treatment if the particulates contaminating the surface S are toxic.

The invention makes it possible to obtain the following advantages:
testing the particulate cleanness of surfaces over a wide range of sizes from the vicinity of a nanometer to an upper limit determined as a function of the nature of the object: this upper limit can be equal to 500 μm, or even a cm,
obtainment of objective proof of the presence of micronic and sub-micronic particulates on the surfaces according to standard ISO 14644-9,
obtainment of morphological information (size range) on the particulates,
obtainment of the surface distribution of the particulates,
guarantee of the confinement of the particulate contamination detached from the surface for possible confinement/treatment or a subsequent physico-chemical analysis.

1-12. (canceled)

13. A method for quantifying surface particulate contaminants likely to be present on an object, according to which the following steps are performed:
a) sampling a surface to be analyzed,
b) raking lighting the sampled surface,
c) taking a first digital photo of the lighted surface to determine elements with a unit size larger than a value X1,
d) blowing clean air on the photographed surface,
e) suctioning the blown air containing any particulate contaminants towards a counting device suitable for quantifying particulates with a unit size below a value X2,
f) taking a second digital photo of the same lighted surface under the same conditions as the first digital photo, so as to differentiate, among the elements, the particulate contaminants from the surface flaws of the object,
g) quantifying particulate contaminants with a unit size larger than X1 by determining the proportion of photographic pixels belonging to any surface contaminants by comparing the first and second digital photos.

14. The method according to claim 13, according to which steps a) to g) are carried out without relative movement in relation to the object.

15. The method according to claim 13, according to which after step g), an additional step is carried out if X1 is less than X2 in which the quantifications are compared between the suctioned and counted particulates and the particulates quantified by digital photography.

16. The method according to claim 13, wherein the suctioned particulates are collected downstream of the counting device.

17. The method according to claim 13, in which raking lighting is done in the ultraviolet range.

18. A device for quantifying surface particulate contaminants likely to be present on an object, comprising:
lighting means for performing raking lighting of a sampled surface,
digital photography means for taking digital photos of the lighted surface, the digital photography means being suitable for determining elements with a unit size greater than a value X1,
blowing means and suction means for blowing clean air on the photographed surface and suctioning the blown air containing any particulate contaminants, respectively,
a counting device adapted to quantify particulates with a size smaller than a value X2,
digital computation means for determining the proportion of photographic pixels belonging to the surface contaminants with a unit size larger than a value X1 through comparison between two digital photos taken before and after blowing and suctioning, respectively.

19. The device according to claim 18, also comprising a filtration membrane whereof the pore size is in the vicinity of the lower counting value of the counting device (X3), the membrane being mounted in the suction means in order to collect the suctioned particulate contaminants.

20. The device according to claim 18, wherein the lighting means comprises ultraviolet lighting means.

21. The device according to claim 18, wherein the lighting means are laser diodes.

22. The device according to claim 18, comprising a contact sole with the object, the sole being made from chemically neutral material(s) relative to the object.

23. The device according to claim 22, also comprising means for generating a non-contaminant air cushion below the contact sole in order to move the device between two different surfaces to be sampled.

12. An application of the method according to claim 13 or of the device according to claim 18, to the quantitative analysis of surface particulate contaminants in controlled environment zones.
